(19) United States
(12) Patent Application Publication
(10) Pub. No.: US 2007/0293310 A1
(43) Pub. Date: Dec. 20, 2007

(54) Fixed-odds/pari-mutuel racing product

(76) Inventors: Barry M. Mindes, Wayne, NJ (US); Bernard J. Albanese, Towaco, NJ (US)

Correspondence Address: AMSTER, ROTHSTEIN & EBENSTEIN LLP, 90 PARK AVENUE, NEW YORK, NY, 10016, US

(21) Appl. No.: 11/800,189

(22) Filed: May 4, 2007

Related U.S. Application Data
(63) Continuation-in-part of application No. 11/675,680, filed on Feb. 16, 2007.
(63) Continuation-in-part of application No. 11/665,680.
(60) Provisional application No. 60/620,949, filed on Oct. 21, 2004.

(51) Int. Cl. G06F 19/00

(52) U.S. Cl. 463/28

(57) ABSTRACT

A computer system for providing fixed-odds pari-mutuel wagering for wagering on entries in a race including: at least one processor; and a computer-readable memory operatively connected to the at least one processor, with instructions capable of performing steps comprising: (a) opening the wagering system with an initial pari-mutuel pool at initial fixed-odds for each entry in the race; (b) evaluating each proposed wager at the initial fixed-odds to determine whether a combination of wagers, in whole or part, would satisfy a predetermined pari-mutuel calculation; (c) accepting or rejecting each proposed wager at the initial fixed-odds, in whole or in part, based on the determination in step (b); (d) based on one or more predetermined criteria, closing the initial pari-mutuel pool to further wagering; (e) optionally providing a subsequent pari-mutuel pool, comprising the steps of: (A) providing a subsequent pari-mutuel pool with optionally modified fixed-odds for each entry in the race; (B) evaluating each proposed wager at the optionally modified fixed-odds to determine whether a combination of wagers, in whole or part, would satisfy a predetermined pari-mutuel calculation; (C) accepting or rejecting each proposed wager at the optionally modified fixed-odds, in whole or in part, based on the determination in step (B); and (D) based on one or more predetermined criteria, closing the subsequent pari-mutuel pool to further wagering; (f) optionally repeating step (e); and (g) closing the wagering system.

### RELATED APPLICATIONS

This application is a continuation-in-part of U.S. patent application Ser. No. 11/665,680 (Attorney Docket No. 43613/22), filed Apr. 18, 2007, which is a U.S. national phase of PCT Application No. PCT/US2005/038057, filed Oct. 21, 2005, which claims priority to U.S. Provisional Application No. 60/620,949, filed Oct. 21, 2004, the contents of which are incorporated herein by reference in their entirety.

### TECHNICAL FIELD

The present invention relates to a wagering system that satisfies pari-mutuel regulations while offering patrons fixed-odds at the time the wager is made. More specifically, the present invention relates to a wagering system whereby patrons may place wagers on horse and greyhound racing, or other pari-mutuel events, on a fixed-odds basis so that once a patron places a wager, the payoff on that wager is fixed based on the terms of the wager when the wager was initially placed.

### BACKGROUND OF THE INVENTION

In most jurisdictions in the United States, the only type of wagering allowed on horse and greyhound racing (collectively “racing”) is pari-mutuel wagering. In pari-mutuel wagering, the house retains a fixed percent of the handle (i.e., the total amount wagered) in each pari-mutuel wagering pool, and the remainder is paid out to those patrons who wagered on the winning entry. The house's retention is the sum of the established fees (for example, commissions, taxes, etc.) that are designated for the track operator, local and state taxing authorities, the owner's association, and others. The key characteristic defining pari-mutuel wagering is that the house's portion is a fixed percentage of the handle; in other words, the house has no financial interest in the outcome of the race, since the house's revenue is identical regardless of which entry wins the race. Pari-mutuel regulations also cover unusual situations such as minimum payout amounts on an entry, “negative” pools, no wagers on the winning entry, rounding down of payoffs (“breakage”), etc.

The handle from pari-mutuel racing in the United States has been declining almost constantly for decades. A major factor in that decline is the way that pari-mutuel pools are currently implemented. When a patron wagers on an entry, he does not know with any certainty the odds he will receive on his wager. He may be able to see displayed the approximate odds at that time, should no additional wagering be entered into that pool. However, these odds are likely to change, often radically, under the influence of the wagering pattern of subsequently placed wagers. The final odds can be calculated, and are available, only after all wagers have been placed, often times only after the race has started. The odds on each entry are equal to the money in the entire pool, less the house retention and less the money wagered on that entry, divided by the money wagered on that entry. The payout to a successful patron equals the amount wagered, multiplied by the odds, plus the amount of the wager.

In much of the world outside of the United States, race wagering is performed on a fixed-odds basis; that is, the house offers to accept wagers on an entry at specific displayed odds. If a patron accepts those odds and places a wager, the payoff on that wager is fixed based on the terms (i.e. the odds and the stake amount) of the wager. The house may subsequently change the odds offered for future wagers placed by other patrons, but any such change would not affect the terms of any wagers already accepted. Fixed-odds wagering is inherently far more attractive to gamblers than the current pari-mutuel wagering because they are able to determine whether the payout to be received on a winning wager is sufficient to compensate for the perceived likelihood that their wager will be won. This usually cannot be determined with reasonable certainty with a pari-mutuel wager.

In these known fixed-odds systems, the house makes a decision on each bet as it is received, as to whether to accept or reject it, in whole or in part, at the odds currently offered on that entry. But since it has no way of knowing the sums that will be subsequently wagered on each entry, the house does know if by accepting any specific wager it will violate the pari-mutuel principle that the total payout on all entries must be the same and must equal the sum of the wagers received on all entries, including the specific wager, less the total house retention. Thus, even though the house has the discretion of accepting or rejecting, in whole or in part, any wager it receives, it has no way of determining the course of action it should take on a specific wager. A calculation made after a wager is accepted can tell if that wager, along with other wagers, satisfy the pari-mutuel calculation, but by then it is too late. The wagers that have been accepted may not satisfy the pari-mutuel calculation, and as there can be no way of knowing the sums of the bets to be subsequently received, it is not possible to assure that the pool of bets accepted can satisfy the pari-mutuel regulations. Thus, the house will usually end up with a financial interest in the outcome of the race as it would be highly coincidental for the total sum of the wagers received to be in the unique ratio that satisfies pari-mutuel regulations for the specific set of fixed-odds offered on the entries in the race, or other type of event.

### SUMMARY OF THE INVENTION

A computer system for providing a fixed-odds pari-mutuel wagering system for wagering on entries in a race according to an exemplary embodiment of the present invention comprises: at least one processor; and a computer-readable memory operatively connected to the at least one processor, with instructions capable of performing steps comprising: (a) opening the wagering system with an initial pari-mutuel pool at initial fixed-odds for each entry in the race; (b) evaluating each proposed wager at the initial fixed-odds to determine whether a combination of wagers, in whole or part, would satisfy a predetermined pari-mutuel calculation; (c) accepting or rejecting each proposed wager at the initial fixed-odds, in whole or in part, based on the determination in step (b); (d) based on one or more predetermined criteria, closing the initial pari-mutuel pool to further wagering; (e) optionally providing a subsequent pari-mutuel pool, comprising the steps of: (A) providing a subsequent pari-mutuel pool with optionally modified fixed-odds for each entry in the race; (B) evaluating each proposed wager at the optionally modified fixed-odds to determine whether a combination of wagers, in whole or part, would satisfy a predetermined pari-mutuel calculation; (C) accepting or rejecting each proposed wager at the optionally modified fixed-odds, in whole or in part, based on the determination in step (B); and (D) based on one or more predetermined criteria, closing the subsequent pari-mutuel pool to further wagering; (f) optionally repeating step (e); and (g) closing the wagering system.

A computer system for providing a payoff based on a fixed-odds pari-mutuel wagering system for wagering on entries in a race according to an exemplary embodiment of the present invention comprises: at least one processor; and a computer-readable memory operatively connected to the at least one processor, with instructions capable of performing steps comprising: (a) sending first signals representative of one or more wagers on entries in the race; (b) opening the wagering system with an initial pari-mutuel pool at initial fixed-odds for each entry in the race using the first signals as input; (c) evaluating each wager at the initial fixed-odds to determine whether a combination of wagers, in whole or part, would satisfy a predetermined pari-mutuel calculation; (d) accepting or rejecting each proposed wager at the initial fixed-odds, in whole or in part, based on the determination in step (c); (e) based on one or more predetermined criteria, closing the initial pari-mutuel pool to further wagering; (f) optionally providing a subsequent pari-mutuel pool, comprising the steps of: (A) providing a subsequent pari-mutuel pool with optionally modified fixed-odds for each entry in the race; (B) evaluating each proposed wager at the optionally modified fixed-odds to determine whether a combination of wagers, in whole or part, would satisfy a predetermined pari-mutuel calculation; (C) accepting or rejecting each proposed wager at the optionally modified fixed-odds, in whole or in part, based on the determination in step (B); and (D) based on one or more predetermined criteria, closing the subsequent pari-mutuel pool to further wagering; (g) optionally repeating step (f); (h) closing the wagering system; and(i) generating second signals representative of a payoff based on a winning wager.

A computer readable medium according to an exemplary embodiment of the present invention has computer executable instructions for performing a method for providing a fixed-odds pari-mutuel wagering system for wagering on entries in a race, and the method comprises the step of: (a) opening the wagering system with an initial pari-mutuel pool at initial fixed-odds for each entry in the race; (b) evaluating each proposed wager at the initial fixed-odds to determine whether a combination of wagers, in whole or part, would satisfy a predetermined pari-mutuel calculation; (c) accepting or rejecting each proposed wager at the initial fixed-odds, in whole or in part, based on the determination in step (b); (d) based on one or more predetermined criteria, closing the initial pari-mutuel pool to further wagering; (e) optionally providing a subsequent pari-mutuel pool, comprising the steps of: (A) providing a subsequent pari-mutuel pool with optionally modified fixed-odds for each entry in the race; (B) evaluating each proposed wager at the optionally modified fixed-odds to determine whether a combination of wagers, in whole or part, would satisfy a predetermined pari-mutuel calculation; (C) accepting or rejecting each proposed wager at the optionally modified fixed-odds, in whole or in part, based on the determination in step (B); and (D) based on one or more predetermined criteria, closing the subsequent pari-mutuel pool to further wagering; (f) optionally repeating step (e); and (g) closing the wagering system.

A system for providing fixed-odds pari-mutuel wagering for wagering on entries in a race according to an exemplary embodiment of the present invention comprises: a fixed-odds engine that determines fixed-odds for each entry in the race; a pari-mutuel pool engine that opens one or more pari-mutuel pools at the predetermined fixed-odds for each entry in the race; a wager filter that accepts or rejects each proposed wager at the predetermined fixed-odds, in whole or in part, based on whether a combination of wagers, in whole or part, would satisfy a predetermined pari-mutuel calculation; and an operation control that closes the one or more pari-mutuel pools to further wagering based on one or more predetermined criteria.

In at least one embodiment, the initial fixed-odds are based upon a knowledgeable estimate of what a population of available patrons will expect the odds on each particular entry to be.

In at least one embodiment, the predetermined pari-mutuel calculation is satisfied when the proposed wager on a particular entry is such that the total payout on that entry at the offered fixed-odds is equal to the total amount accepted in the entire pool minus a house retention.

In at least one embodiment, wherein the predetermined criteria keeps the pari-mutuel pool open for a period of time intended to maximize the total dollar volume of wagers able to be accepted in the pool under the pari-mutuel regulations.

In at least one embodiment, the wagering system remains open until all the wagers that can be accepted are accepted.

In at least one embodiment, the wagering system remains open until the race begins.

In at least one embodiment, the optionally modified fixed-odds take into account a wagering pattern presented by previously placed wagers so that the optionally modified fixed-odds induce patrons to change their wagering patterns.

In at least one embodiment, the only proposed wagers that are accepted are those whose cumulative dollar wager volumes satisfy a predetermined proportional relationship.

In at least one embodiment, the wagering system places partially or completely rejected wagers into a queue.

In at least one embodiment, wagers placed in the queue are still available to be accepted after new wagers at the optionally modified fixed-odds are received.

In at least one embodiment, the wagering system accepts those wagers in the queue when the optionally modified fixed-odds for the wager is equal to or better than the fixed-odds in effect when the wager was placed.

In at least one embodiment, the wagering system is configured to accept lay wagers.

In at least one embodiment, the wagering system is configured to accept wagers on an event where one or more entries, individually or in a combination, win.

In at least one embodiment, the step of evaluating each proposed wager at the initial fixed-odds includes accumulating a number of bets (one or more) at the initial fixed-odds on the entry and then evaluating each proposed wager at the initial fixed-odds, and the substep of evaluating each proposed wager at the optionally modified fixed-odds includes accumulating a batch of bets at those odds and then evaluating each proposed wager at the optionally modified fixed-odds.

In at least one embodiment, the wagering system may accept a variety of wager types selected from the group of wager types consisting of place or show wagers, parlays, exactas, trifectas, superfectas, quinellas, “pick six”, or other types of exotic bets that call for multiple entries being successfully selected as finishing in a prescribed manner.

In at least one embodiment, the wagering system may accept at least one of a fixed-odds bet, a limit bet, or a market bet.

### BRIEF DESCRIPTION OF THE DRAWINGS

Various exemplary embodiments of this invention will be described in detail, with reference to the following figures, wherein:

FIG. 1 is a block diagram of a system for providing fixed-odds pari-mutuel wagering according to an exemplary embodiment of the present invention.

### DETAILED DESCRIPTION OF PREFERRED EMBODIMENTS

The present invention relates to a wagering system that satisfies pari-mutuel regulations while offering patrons fixed-odds at the time a wager is made. For the purposes of promoting an understanding of the principles of the present invention, an exemplary, non-limiting embodiment will be described. It will nevertheless be understood that no limitation of the scope of the invention is hereby intended, such alterations and further modifications are contemplated as would normally occur to one skilled in the art to which the invention relates.

At the outset, the wagering system with an initial pari-mutuel pool offers initial fixed, displayed odds for each entry in a race or other event. The initial odds may be derived, for example, based upon a knowledgeable estimate of what the population of available patrons will expect the odds on each entry to be. Thereafter, the pari-mutuel pool is opened to receive wagers on each participating entry, the bets received are batched and a decision is made upon which bets should be accepted, in whole or part, from the batch. However, the system will only accept wagers on each entry in an amount such that the pari-mutuel calculation (as discussed below) is satisfied. That is, the system will only accept a wager on a particular entry if the total payout on that entry at the offered fixed-odds is equal to the total amount accepted in wagers, including the current wager, less the house retention, i.e., the total amount in the entire pari-mutuel pool, including the amount of the proposed wager, multiplied by the house retention percentage.

A particular pari-mutuel pool will remain open to receive wagers for a period of time that the system determines will likely maximize the total dollar volume of wagers able to be accepted (under the pari-mutuel regulations) in that pool. For example, the system may remain open until all the wagers that can be accepted, are accepted, as will be described in greater detail below, or until some other predetermined criterion is satisfied. Once the system has maximized the total dollar volume of wagers, that pari-mutuel pool may be closed and a subsequent pool opened, with a new set of fixed-odds offered on each entry in the pool.

For subsequent pools, the offered fixed-odds will take into account the wagering pattern presented by the previously placed wagers. That is, some or all of the fixed-odds might be changed from those previously offered, to better reflect the opinion of the available wagering population. Changing the odds has the effect of changing the proportion of wagers on each entry required to satisfy the pari-mutuel regulations. A new proportion will be sought. The new odds will have the effect of inducing the patrons to change their wagering patterns because the new odds are based upon their previously expressed sentiments, as derived from previously placed wagers. The new fixed-odds should thus more closely accord with the patrons' opinions as to what are fair prices and therefore yield wagers which tend to be placed more closely in the desired proportion.

The process may be reiterated at new fixed-odds, successively, in subsequent individual pari-mutuel pools, as long the system determines that additional wagering dollar volume might be accepted in these individual pari-mutuel pools. The start of the race or other criteria might require the cessation of wagering. Note that while each pool will individually satisfy the pari-mutuel regulations, the fixed-odds on the same entry may vary from pool to pool, as the fixed-odds on each entry may be changed to maximize the dollar volume of wagers accepted.

Table I illustrates an example of the required proportion of total dollar amounts of wagers that can be accepted on each entry to satisfy the pari-mutuel regulations. It is assumed in this example that the house wishes to withhold 10% of the total amount wagered. In this table, the fixed-odds are represented by the payoff amount to be paid per unit of wager amount. This payoff includes the return of the patron's wager. This example shows that regardless of which entry wins, the winning patrons will share $90.00, and the house will retain $10, i.e., 10% of the $100 wagered. Other combinations of wager amounts will yield the same house retention of 10%, so long as the ratio of the wagered amount is in the same proportion as those shown in Table 1.

TABLE I
Showing Stake Amounts and Odds Yielding Identical Payoffs

| | | Cumulative | |
|---|---|---|---|
| | | Wager | Cumulative |
| | | Volume | Payoff |
| Entry | Odds | in $ | Amount in $ |
| 1 | 3.00 | 30.00 | 90.00 |
| 2 | 3.60 | 25.00 | 90.00 |
| 3 | 4.50 | 20.00 | 90.00 |
| 4 | 9.00 | 10.00 | 90.00 |
| 5 | 11.25 | 8.00 | 90.00 |
| 6 | 22.50 | 4.00 | 90.00 |
| 7 | 45.00 | 2.00 | 90.00 |
| 8 | 90.00 | 1.00 | 90.00 |
| | Total: | 100.00 | |

As previously stated, in order to qualify under pari-mutuel regulations, the only wagers that can be accepted are those whose cumulative dollar wager volume are in the right proportion. If wagers are received that are in different proportions, then only a subset of the total wagers can be accepted, and that subset would have a dollar wager volume in the proper proportion. This process may include taking a partial wager, that is, taking a wager that represents only a portion of the amount the patron is actually willing to risk. After the wagers that can be accepted, are accepted, there will remain unaccepted wagers (either full or partial) on some but not all of the entries. One or more of the entries will then have no wagers available to be taken.

Wagers that were received prior to the changing of the fixed-odds are placed on a queue and are still available to be taken after new wagers from the new fixed-odds are received. These wagers are placed with a “good until cancelled” understanding, as long as when they are accepted the odds under which they are accepted is equal to or better than the odds indicated on the original wager. Thus, some wagers previously placed might be able to be accepted because more wagers could be accepted at the previous odds, which might still exist, in the new set of fixed-odds. Or, by judiciously increasing the odds for some of the older wagers to newer, higher odds then available, it would be possible for the system to accept a set of wagers, some placed before the odds were changed, and some after, and still have the total dollar wager volume be in the proportion needed to satisfy the pari-mutuel regulations.

The wagering system may accept a form of a place or show wager, or a wager selected from the group consisting of parlay, exacta, trifecta, superfecta, quinella, “pick six”, or other types of exotic bets that call for multiple entries being successfully selected as finishing in a prescribed manner, including but not limited to first, second, third, etc.

As a further extension to the invention, the system may offer the patrons a choice of multiple “types” of wagers, each with different characteristics. For example, in order to increase the likelihood of a wager being accepted by the system, the patron would be allowed to specify one of three limit conditions:
a. Fixed-odds bet (“F” bet)—the patron is indicating that the bet should not be accepted by the system at a price lower than the current price.
b. Limit Bet (“L” bet)—the patron is indicating that the bet should not be accepted by the system at a price lower than the limit price.
c. Market Bet (“M” bet)—the patron is indicating that he wants his bet accepted, and is willing to accept any price without limitation.

When making a bet, the patron will indicate the limit condition preference. One option would be the default. Just prior to submitting the bet, the patron would be able to change his/her limit selection. If the patron chooses an L bet, the patron will indicate the desired Limit Price. One possibility is to allow the patron free rein and allow him/her to enter his own Limit Price. For ease of use, and for reasons of system efficiency, it may be preferable to let the patron choose the Limit Price from a list of one or more pre-calculated prices offered by the system (for example, prices which provides a return 10% or 20% less that the current price).

Because an L bet allows the system to accept a wager at a price below the current price (but not lower than the limit price), the L bet provides flexibility to the system. That is, it will be easier to find a combination of wagers that satisfy the pari-mutuel calculations. By extension, the M bet provides even greater flexibility to the system. In order to encourage patrons to make use of these more flexible bet

types, when wagers are accepted by the system, M bets will be given priority, followed by L bets (in order of most price flexibility, i.e. lowest Limit Prices), with F bets having the lowest priority.

As those of skill in the art will appreciate, one could use the wagering system of the present invention, with relatively small extensions, to also accept “lay” wagers, that is, wagers that an entry will not win. It should be noted that a lay wager is equivalent to placing normal (back) wagers in the proper dollar proportion on all entries but the entry upon which the lay wager was offered. Similarly, a series of back wagers on all but one of the entries, in the proper proportion, is equivalent to a lay wager. Additionally, back and lay wagers on the same entry could be accepted if the payouts are equal, after the house retention is subtracted. The wagering system of the present invention also can be extended to accept wagers in cases where more than one entry wins, such as “place” and “show” wagers.

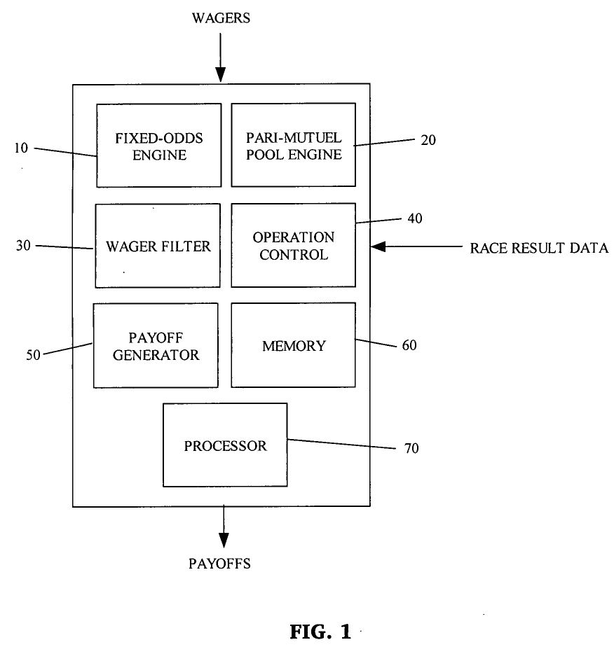

It should be appreciated that the various exemplary systems and methods described herein may be implemented on a computer-based system. For example, FIG. 1 shows a system, generally designated by reference number 1, for providing fixed-odds pari-mutuel wagering according to an exemplary embodiment of the present invention. The system 1 includes a fixed-odds engine 10, a pari-mutuel pool engine 20, a wager filter 30, an operation control 40, a payoff generator 50, a memory unit 60 and a processor 70. The various components of the system 1 may be, for example, software components that provide computer programming instructions to the processor 70, one or more hardware components, or a combination of hardware and software components.

The fixed-odds engine 10 calculates fixed-odds for each pari-mutuel pool generated by the system 1. The fixed-odds may be calculated using a set of criteria, such as, for example, a knowledgeable estimate of what a population of available patrons will expect the odds on each particular entry to be, or estimates based on what the house expects the odds to be. The fixed-odds engine 10 may also modify the fixed-odds in subsequent iterations which take into account a wagering pattern presented by previously placed wagers.

The pari-mutuel pool engine 20 generates an initial pari-mutuel pool at initial fixed-odds for each entry in the race, and optionally generates one or more subsequent pari-mutuel pools based on optionally modified fixed-odds.

The wager filter 30 evaluates each proposed wager at the initial fixed-odds to determine whether a combination of wagers, in whole or part, would satisfy a predetermined pari-mutuel calculation. For example, the predetermined pari-mutuel calculation may be satisfied when the proposed wager on a particular entry is such that the total payout on that entry at the offered fixed-odds is equal to the total amount accepted in the entire pool minus a house retention. The wager filter 30 may place wagers that are partially or completely rejected in a queue. The wagers placed in the queue may be available for acceptance after new wagers at optionally modified fixed-odds are received. Queued wagers may be accepted when the optionally modified fixed-odds for the wager is equal to or better than the fixed-odds in effect when the wager was placed. The wager filer 30 may also be configured to accept a variety of wager types, such as, for example, lay wagers, wagers on an event where more than one entry, individually or in a combination, wins, place or show wagers, parlay wagers, exacta wagers, trifecta wagers, superfecta wagers, quinella wagers, “pick six” wagers, other types of exotic bets that call for multiple entries being successfully selected as finishing in a prescribed manner, fixed-odds bets, limit bets, or market bets.

The operation control 40 closes the initial pari-mutuel pool and any subsequent pari-mutuel pools to further wagering based on one or more predetermined criteria. In this regard, the predetermined criteria may keep the pari-mutuel pool open, for example, for a period of time intended to maximize the total dollar volume of wagers able to be accepted in the pool under the pari-mutuel regulations, until all the wagers that can be accepted are accepted, or until the race begins.

The payoff generator 50 may calculate payoff amounts to winning players using the wagers and race result data as input. In this regard, the payoff generator 50 may calculate payoff amount by summing the total amount of wagers accepted in the entire pool and subtracting a house retention amount.

The present invention has been described in connection with the above-illustrated example. The present invention, however, is not restricted thereto. It will be understood by those skilled in the art that other variations and modifications can easily be made within the scope of the invention as defined by the appended claims, thus it is only intended that the present invention be limited by the following claims.

What is claimed is:

1. A computer system for providing a fixed-odds pari-mutuel wagering system for wagering on entries in a race, comprising:
at least one processor; and
a computer-readable memory operatively connected to the at least one processor, with instructions capable of performing steps comprising:
(a) opening the wagering system with an initial pari-mutuel pool at initial fixed-odds for each entry in the race;
(b) evaluating each proposed wager at the initial fixed-odds to determine whether a combination of wagers, in whole or part, would satisfy a predetermined pari-mutuel calculation;
(c) accepting or rejecting each proposed wager at the initial fixed-odds, in whole or in part, based on the determination in step (b);
(d) based on one or more predetermined criteria, closing the initial pari-mutuel pool to further wagering;
(e) optionally providing a subsequent pari-mutuel pool, comprising the steps of:
(A) providing a subsequent pari-mutuel pool with optionally modified fixed-odds for each entry in the race;
(B) evaluating each proposed wager at the optionally modified fixed-odds to determine whether a combination of wagers, in whole or part, would satisfy a predetermined pari-mutuel calculation;
(C) accepting or rejecting each proposed wager at the optionally modified fixed-odds, in whole or in part, based on the determination in step (B); and
(D) based on one or more predetermined criteria, closing the subsequent pari-mutuel pool to further wagering;
(f) optionally repeating step (e); and
(g) closing the wagering system.

2. The computer system of claim 1, wherein the initial fixed-odds are based upon a knowledgeable estimate of what a population of available patrons will expect the odds on each particular entry to be.

3. The computer system of claim 1, wherein the predetermined pari-mutuel calculation is satisfied when the proposed wager on a particular entry is such that the total payout on that entry at the offered fixed-odds is equal to the total amount accepted in the entire pool minus a house retention.

4. The computer system of claim 1, wherein the predetermined criteria keeps the pari-mutuel pool open for a period of time intended to maximize the total dollar volume of wagers able to be accepted in the pool under the pari-mutuel regulations.

5. The computer system of claim 1, wherein the wagering system remains open until all the wagers that can be accepted are accepted.

6. The computer system of claim 1, wherein the wagering system remains open until the race begins.

7. The computer system of claim 1, wherein the optionally modified fixed-odds take into account a wagering pattern presented by previously placed wagers so that 3 the optionally modified fixed-odds induce patrons to change their wagering patterns.

8. The computer system of claim 1, wherein the only proposed wagers that are accepted are those whose cumulative dollar wager volumes satisfy a predetermined proportional relationship.

9. The computer system of claim 1, wherein the wagering system places partially or completely rejected wagers into a queue.

10. The computer system of claim 9, wherein wagers placed in the queue are still available to be accepted after new wagers at the optionally modified fixed-odds are received.

11. The computer system of claim 9, wherein the wagering system accepts those wagers in the queue when the optionally modified fixed-odds for the wager is equal to or better than the fixed-odds in effect when the wager was placed.

12. The computer system of claim 1, wherein the wagering system is configured to accept lay wagers.

13. The computer system of claim 1, wherein the wagering system is configured to accept wagers on an event where one or more entries, individually or in a combination, win.

14. The computer system of claim 1, wherein the step of evaluating each proposed wager at the initial fixed-odds includes accumulating a number of bets (one or more) at the initial fixed-odds on the entry and then evaluating each proposed wager at the initial fixed-odds, and the substep of evaluating each proposed wager at the optionally modified fixed-odds includes accumulating a batch of bets at those odds and then evaluating each proposed wager at the optionally modified fixed-odds.

15. The computer system of claim 1, wherein the wagering system may accept a variety of wager types selected from the group of wager types consisting of place or show wagers, parlays, exactas, trifectas, superfectas, quinellas, “pick six”, or other types of exotic bets that call for multiple entries being successfully selected as finishing in a prescribed manner.

16. The computer system of claim 1, wherein the wagering system may accept at least one of a fixed-odds bet, a limit bet, or a market bet.

17. A computer readable medium having computer executable instructions for performing a method for providing a fixed-odds pari-mutuel wagering system for wagering on entries in a race, the method comprising the step of:
(a) opening the wagering system with an initial pari-mutuel pool at initial fixed-odds for each entry in the race;
(b) evaluating each proposed wager at the initial fixed-odds to determine whether a combination of wagers, in whole or part, would satisfy a predetermined pari-mutuel calculation;
(c) accepting or rejecting each proposed wager at the initial fixed-odds, in whole or in part, based on the determination in step (b);
(d) based on one or more predetermined criteria, closing the initial pari-mutuel pool to further wagering;
(e) optionally providing a subsequent pari-mutuel pool, comprising the steps of:
(A) providing a subsequent pari-mutuel pool with optionally modified fixed-odds for each entry in the race;
(B) evaluating each proposed wager at the optionally modified fixed-odds to determine whether a combination of wagers, in whole or part, would satisfy a predetermined pari-mutuel calculation;
(C) accepting or rejecting each proposed wager at the optionally modified fixed-odds, in whole or in part, based on the determination in step (B); and
(D) based on one or more predetermined criteria, closing the subsequent pari-mutuel pool to further wagering;
(f) optionally repeating step (e); and
(g) closing the wagering system.

18. The computer readable medium of claim 17, wherein the initial fixed-odds are based upon a knowledgeable estimate of what a population of available patrons will expect the odds on each particular entry to be.

19. The computer readable medium of claim 17, wherein the predetermined pari-mutuel calculation is satisfied when the proposed wager on a particular entry is such that the total payout on that entry at the offered fixed-odds is equal to the total amount accepted in the entire pool minus a house retention.

20. The computer readable medium of claim 17, wherein the predetermined criteria keeps the pari-mutuel pool open for a period of time intended to maximize the total dollar volume of wagers able to be accepted in the pool under the pari-mutuel regulations.

21. The computer readable medium of claim 17, wherein the wagering system remains open until all the wagers that can be accepted are accepted.

22. The computer readable medium of claim 17, wherein the wagering system remains open until the race begins.

23. The computer readable medium of claim 17, wherein the optionally modified fixed-odds take into account a wagering pattern presented by previously placed wagers so that 3 the optionally modified fixed-odds induce patrons to change their wagering patterns.

24. The computer readable medium of claim 17, wherein the only proposed wagers that are accepted are those whose cumulative dollar wager volumes satisfy a predetermined proportional relationship.

25. The computer readable medium of claim 17, wherein the wagering system places partially or completely rejected wagers into a queue.

26. The computer readable medium of claim 25, wherein wagers placed in the queue are still available to be accepted after new wagers at the optionally modified fixed-odds are received.

27. The computer readable medium of claim 25, wherein the wagering system accepts those wagers in the queue when the optionally modified fixed-odds for the wager is equal to or better than the fixed-odds in effect when the wager was placed.

28. The computer readable medium of claim 17, wherein the wagering system is configured to accept lay wagers.

29. The computer readable medium of claim 17, wherein the wagering system is configured to accept wagers on an event where one or more entries, individually or in a combination, win.

30. The computer readable medium of claim 17, wherein the step of evaluating each proposed wager at the initial fixed-odds includes accumulating a number of bets (one or more) at the initial fixed-odds on the entry and then evaluating each proposed wager at the initial fixed-odds, and the substep of evaluating each proposed wager at the optionally modified fixed-odds includes accumulating a batch of bets at those odds and then evaluating each proposed wager at the optionally modified fixed-odds.

31. The computer readable medium of claim 17, wherein the wagering system may accept a variety of wager types selected from the group of wager types consisting of place or show wagers, parlays, exactas, trifectas, superfectas, quinellas, “pick six”, or other types of exotic bets that call for multiple entries being successfully selected as finishing in a prescribed manner.

32. The computer readable medium of claim 17, wherein the wagering system may accept at least one of a fixed-odds bet, a limit bet, or a market bet.

33. A system for providing fixed-odds pari-mutuel wagering for wagering on entries in a race, comprising:
a fixed-odds engine that determines fixed-odds for each entry in the race;
a pari-mutuel pool engine that opens one or more pari-mutuel pools at the predetermined fixed-odds for each entry in the race;
a wager filter that accepts or rejects each proposed wager at the predetermined fixed-odds, in whole or in part, based on whether a combination of wagers, in whole or part, would satisfy a predetermined pari-mutuel calculation; and
an operation control that closes the one or more pari-mutuel pools to further wagering based on one or more predetermined criteria.
